(19) United States
(12) Patent Application Publication
(10) Pub. No.: US 2011/0035808 A1
(43) Pub. Date: Feb. 10, 2011

(54) ROOTKIT-RESISTANT STORAGE DISKS

(75) Inventors: Kevin R. Butler, State College, PA (US); Stephen E. McLaughlin, State College, PA (US); Patrick D. McDaniel, State College, PA (US)

Correspondence Address: GIFFORD, KRASS, SPRINKLE,ANDERSON & CITKOWSKI, P.C, PO BOX 7021, TROY, MI, 48007-7021, US

(73) Assignee: The Penn State Research Foundation, University Park, PA (US)

(21) Appl. No.: 12/851,046

(22) Filed: Aug. 5, 2010

Related U.S. Application Data
(60) Provisional application No. 61/231,448, filed on Aug. 5, 2009.

(51) Int. Cl. G06F 21/24

(52) U.S. Cl. 726/27

(57) ABSTRACT

Rootkit-resistant disks (RRD) label all immutable system binaries and configuration files at installation time. During normal operation, the disk controller inspects all write operations received from the host operating system and denies those made for labeled blocks. To upgrade, the host is booted into a safe state and system blocks can only be modified if a security token is attached to the disk controller. By enforcing immutability at the disk controller, a compromised operating system is prevented from infecting its on-disk image.

### REFERENCE TO RELATED APPLICATION

This application claims priority from U.S. Provisional Patent Application Ser. No. 61/231,448, filed Aug. 5, 2009, the entire content of which is incorporated herein by reference.

### FIELD OF THE INVENTION

This invention relates generally to computer malware and, in particular, to a rootkit-resistant disk (RRD) that prevents rootkit persistence.

### BACKGROUND OF THE INVENTION

Rootkits exploit operating system vulnerabilities to gain control of a victim host. For example, some rootkits replace the system call table with pointers to malicious code. The damage is compounded when such measures are made persistent by modifying the on-disk system image, e.g., system binaries and configuration. Thus, the only feasible way of recovering from a rootkit is to wipe the disk contents and reinstall the operating system [20, 3, 19, 13]. Worse still, once installed, it is in almost all cases impossible to securely remove them. The availability of malware and the economic incentives for controlling hosts has made the generation and distribution of rootkits a widespread and profitable activity [44].

Rootkit-resistant operating systems do not exist today, nor are they likely to be available any time soon; to address rootkits is to largely solve the general problem of malicious software. Current operating system technologies provide better tools than previously available at measuring and governing software [34], but none can make the system impervious to rootkits without placing unreasonable restrictions on their operation. However, while it is currently infeasible to prevent an arbitrary rootkit from exploiting a given system, we observe that preventing them from being becoming persistent is a significant step in limiting both their spread and damage.

Rootkits themselves are not used to exploit a system, but are often used in conjunction with exploits to maintain a persistent presence on a system after it has been compromised. In this sense, they often share commonalities with programs such as Trojan horses [59]. Software to exploit systems has been a topic of extensive and ongoing research. Tools that generate exploits are readily available [36], and defending against malicious code, particularly if it is polymorphic, is extremely difficult. Identifying polymorphic viruses bounded in length has been shown to be NP-complete [55], while modeling the polymorphic attacks (such as polymorphic blending attacks [14]) requires exponential space [52]. The transmission vector for these exploits is often a worm [53], which can compromise large numbers of machines in very short time periods [57].

Numerous proposals to defend against rootkits have varied in their complexity and coverage. Signature-based schemes such as chkrootkit [41] are limited in that they rely on the operating system to correctly scan for rootkits, which may have subverted the OS to protect against these defenses. Rootkit scanners that are implemented as kernel modules (e.g., rkscan) [2] provide better protection, but can only detect a rootkit when it is present, potentially allowing it to have subverted the kernel to protect against these scanners. Kruegel et al. [30] present a scheme to detect rootkits by checking kernel modules at load time, but this does not protect against a kernel code injection that bypasses the module loader. Once the rootkit is installed, it can modify the boot sequence, which is prevented in our scheme. Detection is always optimal, but our proposal provides a solution in the cases where we cannot prevent a kernel compromise. General malware tracking schemes such as Panorama [61] may be useful for preventing rootkit installation but exact a very heavy performance penalty.

Cryptographic file systems such as CFS [5], TCFS [7], and CryptFS [62], provide data protection through encryption at the file system level, allowing users to encrypt at the granularity of files and directories. Other schemes that provide volume-based encryption, e.g., SFS [35, 15] operate transparently to the user but do not provide granularity at a file or directory level. Our proposal for RRDs calls for securing data at the block level, below the file system. Security of data below the file system has been an area of significant research, particularly with the advent of network-attached disks that accept direct block reads and writes. Network-attached secure disks (NASD) [17, 16] sought to associate metadata with on-disk data through a server. Schemes such as SNAD [38], which seek to secure network attached disks, or SNARE [63], which provides key distribution across multiple storage devices, require the use of an ancillary metadata or authorization server. SCARED [46] provides data integrity but not at the block layer, so operations cannot be performed by the disk; Oprea provides integrity at the block [43] and file system layer [42], both relying on correct workload characterization to parameterize an entropy threshold, and requiring a source of trusted storage. Aguilera et al. [1] consider block-based capabilities that rely on access control at a metadata server. All of these solutions provide cryptographic services but do not protect the operating system against exploits. Plutus [25] considers the idea of the storage system being malicious and provides block-based access where management is performed by clients of the disk, while SiRiUS [18] and SUNDR [32] provide services at the file system level. These approaches, however, are concerned with protecting the clients against malicious data stores, while in our proposal, we are concerned with protecting the client by protecting the data itself.

The concept of storage that is independently secured was explored by Strunk et al. [58]. In this model, the focus is on objects that act as capabilities, in a similar manner to NASD but with a focus on intrusion detection [45] and recovery from these types of attacks, through the use of on-disk audit logs and primarily considering versioning of objects.

### SUMMARY OF THE INVENTION

This invention is directed to a rootkit-resistant disk (RRD) that prevents rootkit persistence. The solution is built on increasingly available intelligent disk capabilities to tightly govern write access to the system image within the embedded disk processor. Because the security policy is enforced at the disk processor (rather than in the host OS), a successful penetration of the operating system provides no access to modify the system image.

The preferred embodiment operates as follows:
An administrative token containing a system write capability in placed in the USB port of the external hard drive enclosure during the installation of the operating system. This ensures that the disk processor has access to the capability, but the host CPU does not.
Associated with every block is a label indicating whether it is immutable. Disk blocks associated with immutable system binaries and data are marked during system installation. The token is removed at the completion of the installation.
Any modification of an immutable system block during normal operation of the host OS is blocked by the disk processor.
System upgrades are performed by safely booting the system with the token placed in the device (and the system write capability read), and the appropriate blocks marked. The token is removed at the completion of the upgrade.

An RRD superficially provides a service similar to that of “live-OS” distributions, i.e., images that boot off read-only devices such as a CD. However, an RRD is a significant improvement over such approaches in that (a) it can intermix and mutable data with immutable data, (b) it avoids the often high overheads of many read-only devices, and (c) it permits (essential) upgrading and patching. In short, it allows the host to gain the advantages of a tamper-resistant system image without incurring the overheads or constraints of read-only boot media.

### BRIEF DESCRIPTION OF THE DRAWINGS

FIGS. 1A and 1B show the use of tokens for labeling data in the RRD; specifically, FIG. 1A shows how the host system writes a file to unused disk space using the gray token, and FIG. 1B shows any blocks written while the black token is in the disk are labeled accordingly, and any attempts to write gray labeled data are denied as long as the gray token is not present;

FIG. 2 shows the prototype RRD, as block requests are intercepted at the client by the RRD driver and sent to a “slug” over TCP;

FIG. 3 shows the RRD prototype, comprising a Linksys NSLU2 storage link (slug), a Seagate Free Agent Pro external hard drive, and a USB flash memory drive connected to a hub for clarity;

FIG. 4 shows a comparison of used blocks versus labeled blocks; and

FIG. 5 shows the number of ranges in BLOCK-LABELS compared with the number of labeled blocks.

### DETAILED DESCRIPTION OF THE INVENTION

In this disclosure, we present the design and analysis of a rootkit-resistant disk (RRD). The system architecture, implementation, and evaluation are detailed and design alternatives that enable performance and security optimizations discussed. A version of the RRD was implemented on a Linksys NSLU2 network storage device [33] by extending the I/O processing on the embedded disk controller and using USB flash memory devices for security tokens. Our implementation integrates label and capability management within the embedded software stack (SlugOS Linux distribution [50]). We further extend the host operating system kernel and installation programs to enable the use of the non-standard RRD interfaces and security tokens: however, in practice, modifications to host operating systems will not be needed.

Our performance evaluation shows that the RRD exhibits small performance and resource overheads. The experiments show an overhead of less than 1 percent for filesystem creation and less than 1.5 percent during I/O intensive Postmark benchmarking. Further investigation shows that the approach imposes a storage overhead of less than 1 percent of the disk in a worst-case experiment. We experimentally demonstrate the viability of the RRD as a rootkit countermeasure by infecting and recovering from a rootkit collected from the wild. Furthermore, we show through examination of the chkrootkit utility that a large number of rootkits would be rendered non-persistent through use of the RRD.

Mutable configuration and binary files that can compromise the system (such as user cron [60] jobs), can reinfect the system after reboot. However, once patched, the system will no longer be subject to the whims of that malware. This represents a large step forward in that it introduces a previously unavailable feasible path toward recovery. Note that the RRD does not protect the system's BIOS (which is burned into system PROM/EPROM/flash). The RRD does, however, protect all portions of the boot process that use immutable code or data, including the master boot record (MBR).

To understand the requirements for designing storage solutions that resist persistent rootkits, we first examine their nature and operation and commonalities that exist between them. We first present a background on how rootkits have operated to date, then layout requirements for disks that prevent persistent rootkits and the design decisions that we made to implement these goals.

Rootkits have been well-studied, and those that attack the operating system and reside in the kernel have been demonstrated in both theory and practice [21]. They can be user-mode programs that perform functions such as adding inline hooks into system functions or patching runtime executables dynamically (e.g., system commands such as ps, netstat, and top), or kernel-mode programs that hook into the kernel, layer themselves onto device drivers, or directly manipulate the OS kernel, and sometimes the hardware itself [24]. Rootkits can be persistent, where they survive a system reboot, or non-persistent, where they install themselves into volatile memory and do not survive across reboots [22].

Numerous techniques for hiding rootkits have been implemented, including modification of system files and libraries [8], boot sector modification [51], and altering the ACPI code often stored in the BIOS [23]—this approach may potentially even evade detection by a TPM, by causing it to report correct hash values [26]. While many of these attacks can be fended off through integrity protection mechanisms [27, 40] and kernel-level rootkit detectors [5, 47], increasingly sophisticated rootkits can evade this level of detection. Such attacks can subvert virtual memory [54] or install themselves as a virtual machine monitor underneath the operating system itself [28], demonstrating that whoever controls the lowest layer of the system gains the advantage in attacking or defending it.

With all of these rootkits, a successful compromise means that data is susceptible to exposure. By using RRDs, however, the user can effectively reside at a lower level than the OS by directly interfacing the disk with a physical token to arbitrate access to data. The rootkit will thus be unable to gain access to read and write data on portions of the drive that the user does not have access to, regardless of OS compromise. This provides a level of on-disk protection that has not previously been feasible.

To provide a practical solution for an RRD, we need to ensure that the following four goals are satisfied:
It must protect against real rootkits. The RRD must demonstrably protect against currently deployed persistent kernel-level rootkits.
It must be usable without user interaction and with minimal administration. The operation of the RRD should be transparent during normal operation.
It must be highly performant. Accessing storage must be feasible with as little performance overhead as possible, given the rigorous demands for I/O throughput.
It must have low storage overhead. The RRD should consume as little ancillary storage for metadata and use as little additional space on the disk as possible.

Designing a suitable solution that fulfills the above requirements presents the following two challenges:
As storage requests travel from a system call to the file system to the storage, context about what is being asked for is lost. For example, knowing whether requests for blocks are related to each other (e.g., are write requests associated with the same file or application) is not possible at the storage layer because this information has been removed. This results in a semantic gap between file and storage systems (as described by many, including Sivathanu et al. [49]). Data security policies are often defined at the file level, but the semantic gap makes the task of extending these policies to the disk interface difficult, if not impossible, to implement within conventional operating systems.
Enforcement of security in storage independently of the operating system depends on the availability of a trusted administrative interface. The disk interface has traditionally been limited to that of the system bus, as accessible by CPU and possibly DMA controller. This interface is fully accessible to the OS and thus is effectively compromised if the OS is compromised.

We fundamentally address the semantic loss by not relying on the file layer to provide context to the disk. Instead, the administrator inserts a token into the disk when data is to be write-protected. The token acts to label the blocks written to disk, such that without the token present, they cannot be overwritten. By doing this, the administrator provides context to the disk: it can differentiate between labeled and unlabeled blocks, and between blocks labeled with different tokens. The token may be physically plugged into the drive (e.g., using a smart card or USB token).¹ We say that any data blocks written under a specific token are bound to that token, such that they are rendered read-only whenever the token is not present. Such data will be immutable to alteration on disk by any processes within the operating system. Only a small subset of the data on a disk will be bound in this manner, notably the binaries and important sectors on a disk (e.g., the MBR) that would otherwise be susceptible to being overwritten by a rootkit. The write-time semantics associated with tokens are a natural consequence, given that administrative operations requiring the presence of tokens are performed on system data at well-defined times (e.g., during file system creation, system installation, and package installation). 1 Note that proximity-based solutions such as ZIA [10] do not convey intention and hence would not be suitable for this design.

The action of inserting a physical token addresses our second challenge, as the user is a trusted interface to the disk that cannot be subverted by a compromised operating system. In essence, we have reduced the trust problem to that of physical security of the user and her associated tokens. As previously noted, our model seeks to protect against persistent rootkits that have compromised the operating system; thus, we consider the user a trusted component in the system rather than an adversary. In addition, physical attacks such as forging of the tokens, or attacking the drive itself by opening it to scan its memory for metadata, are outside our protection model. Implementing tamperproof interfaces into the drive appear contrary to the marketplace desires for inexpensive, high-performance storage. However, building additional security into the drive enclosure in a similar manner to the IBM 4758 secure co-processor [12] is a design point that is feasible to achieve if the cost-benefit ratio for a specific application dictates it to be appropriate.

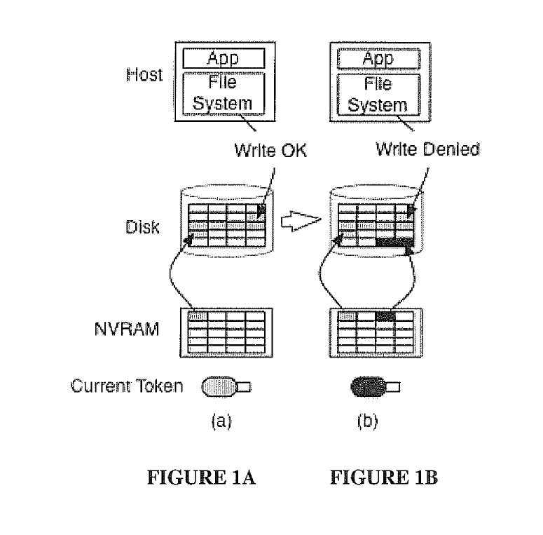

An RRD has two modes of operation. Under normal operation, the RRD is used like a regular disk, without any tokens present. This is the mode of operation that a regular user will always use the disk in, as will the administrator for the majority of the time. Only during an administrative event will the disk be used in administrator mode. We define an administrative event to be one that affects the system as a whole and that only an administrator can execute. Examples of these would be the initial installation of an operating system onto the disk and subsequent upgrades to the operating system, e.g., software package upgrades or full distribution upgrades. Administrative mode is activated by inserting a token into the disk. As shown in FIG. 1, data blocks written then become labeled with the inserted token and become immutable. Blocks labeled as immutable may only be rewritten when the token associated with the label is inserted into the disk. If the block has not been written under a token, or if it is written without the presence of a token, it is mutable and hence not write-protected. By differentiating between mutable and immutable blocks, we can allow certain files such as startup scripts to be only writable in the presence of a token, while not forcing such a stipulation on files that should be allowed to be written, such as log file.

There is a special token in our system that acts in a manner different than described above. Because of the need for processes to be able to write certain filesystem metadata, such as logs and journals, we introduce the concept of a permanently mutable data block. Blocks labeled permanently mutable (denoted lₚₘ) during filesystem creation are writable by all processes (subject to operating system protections, e.g., UNIX permissions), regardless of whether the token is installed or not.

In a scenario where the drive is used to separate binaries that may end up as vectors for rootkits and being loaded at boot time, only one token may be necessary. This token would be used only when system binaries are installed, as that would be the only time they would require being written to the disk. Greater isolation may be achieved by using separate tokens while performing different roles, e.g., a token for installing binaries and another for modifying configuration files. By differentiating between mutable and immutable blocks, we can allow certain files such as startup scripts to be only writable in the presence of a token, while not forcing such a stipulation on files that should be changing, such as document files within a user's home directory.

| | |
|---|---|
| 1: | For all blk in Request do |

| | |
|---|---|
| 2: | l_{B} ← LABELOF{blk} |
| 3: | lₜ ← LABELFROMTOKEN { } |
| 4: | if l_{B} ≠ nil and l_{B} ≠ lₚₘ and l_{B} ≠ lₜ then |

| | |
|---|---|
| 5: | return ‘Write denied’ |

| | |
|---|---|
| 6: | end if |
| 7: | if l_{B} = nil and lₜ ≠ nil then |

| | |
|---|---|
| 8: | l_{B} ← lₜ |

| | |
|---|---|
| 9: | end if |

| | |
|---|---|
| 10: | end for |
| 11: | return ‘Write OK’ |

Algorithm 1: RRD-write. Only if a block is unlabeled or has the same label lₜ as the inserted token will the write be successful; otherwise, if there is a label mismatch or the block is labeled permanently mutable lₚₘ, the write will fail.

When the RRD receives a write request for some contiguous region of blocks, R={bᵢ, bᵢ₊₁, . . . bⱼ}, it obtains the label lₜ from the current token. If no token is present in the disk then lₜ=nil, in which case the RRD verifies that no mutable blocks are included in R. If lₜ is the permanently mutable label lₚₘ, any unlabeled blocks in R are labeled with lₚₘ and the write is allowed. If the token contains any other label, all blocks in the request are checked for equality with that label, and any nil blocks are labeled accordingly. The RRD's write policy is specified in Algorithm 2.4.

Once a block has been labeled as immutable or permanently mutable, its label cannot be changed. Thus, in a system where immutable data is often written, the possibility of label creep [48] arises. Because of the semantic gap between the file and storage layers, we are unable to perform free space reclamation in storage when files are deleted. This leads to labeled blocks becoming unusable, as while they have been freed by the file system, they remain write-protected by the disk. We find in our examination of label creep that its effects on an RRD are limited; we investigate this facet of operation through experimentation in greater detail below. It is possible to mitigate the effects of label creep through unlabeling of tokens.

We now outline the steps by which an RRD would be set up and operated. An RRD may be shipped pre-formatted with the appropriate labeled tokens, or the user may perform the initial set up of the device. It is important at this stage to boot the system where the disk is to be set up into a state that is free of rootkits that may infect the machine; the disk is in a vulnerable state at this point. While a trusted boot prior to the installation of an RRD (and with regards to BIOS integrity) is outside the our scope of feasibility, a method of ensuring a trusted system setup could involve the use of a root of trust installation [56] where the system is booted from a trusted CD and the subsequent boot and installation is measured for integrity at every stage.

Once the system is booted, the disk may be formatted. The simplest and safest manner for setting up the drive is to define a system partition that holds the OS binaries and configuration files, and a user partition for other data. During partitioning, the token must be inserted to protect the MBR. The system partition may then be formatted without an installed token such that the filesystem is mutable (i.e., data may be written to it). As mentioned above, certain special filesystem structures (e.g., a filesystem journal²) may need to be always writable. The blocks allocated to these structures should be written with the permanently-mutable token. 2 Note that we do not currently support full journal functionality in a filesystem like ext3, because journaled data may be written to labeled blocks at a time when the token is not in the disk. We discuss a small filesystem modification that supports full ext3 journaling.

At this point, the operating system may be installed on the disk. A token should be inserted in the disk to move the RRD into administrative mode. This will render important binaries (e.g., programs installed in the /usr/bin hierarchy in a UNIX-like system) and configuration files immutable. Finer-grained access is possible at this point; for example, if there is a desire for access to writing binaries to be decoupled with access to configuration files, the installer can be partitioned to first write the binaries with an appropriate binaries token before writing configuration files (e.g., the /etc hierarchy) with a configuration token. Once the installation is complete, the user partition may be formatted and the disk is ready to be operated

Normal operation of the system should preclude the need for any involvement of physical tokens. Only when system updates or changes to the configuration are necessary will tokens be necessary. To prevent the token from affecting other files during an upgrade, it is optimal to perform these operations in their own runlevel, such that processes are stopped and labels are not inadvertently written to incorrect blocks. It is also important that the operating system synchronize its data with the disk by flushing buffers (e.g., through the sync command) when the upgrade is completed and before the token is removed. At this point, the system may return to its previous runlevel and operations may continue as usual. Note that we cannot protect against system upgrades that are already compromised as may be the case, and protections against upgrade tampering are insufficient in current software update mechanisms [4]. An RRD can protect against persistent rootkits that attack the system when the token is not installed, but if a program contains a trojan or other exploit and is installed when an administrative token is present, it will have the ability to attack the boot process and install itself to maintain persistence.

We implemented an RRD that fulfills block requests over TCP. The choice to use a network interface was made as development of firmware for commodity disks is prohibitively difficult due to a lack of open firmware and development environments. Our prototype RRD provides the same functionality and security guarantees described above, and can be used as the root partition of a running system. Because the prototype exports a nonstandard interface, we developed a driver for disk-to-host communication. This driver would normally not be necessary given a disk with a standard interface, e.g. SCSI, and contributes nothing to the security of our scheme. Finally, we create an installer to simplify the processes of installing a base system on an RRD. We now describe the implementation details of our prototype, as well as the RRD driver and installer.

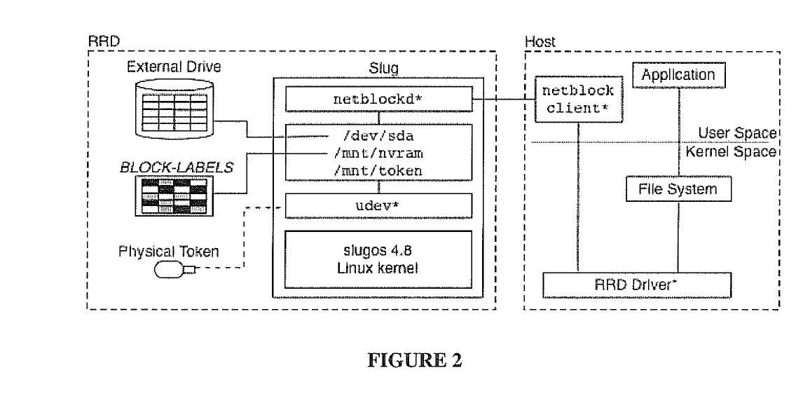

The prototype RRD has two components: a Linksys NSLU2 network attached storage link [33], commonly referred to as a “slug”, and an external USB hard disk. The setup of this prototype is shown in FIG. 2. The external hard disk is a standard model and offers no additional functionality beyond the typical SCSI command interface. The slug is a network storage link, an embedded device that acts as a bridge between an external. USB hard disk and a network attached storage (NAS) device. It has one RJ45 jack which provides the network interface, and two USB-2.0 ports used for the exported storage devices. In our case, we use one of the USB ports for the disk and the other for USB thumb drives which constitute the physical tokens. The role of the slug is threefold:
Receive block requests from the network;
Store and enforce the RRD's policy;
Act as an entry point for physical tokens.

In order to develop software for the slug, we replaced its default firmware with the SlugOS Linux distribution [50]. We then uploaded netblockd, a server program we developed to satisfy block I/O requests over TCP sockets. netblockd consists of 2,665 lines of code and was cross-compiled for the slug using the OpenEmbedded framework [31]. netblockd satisfies all requests from the USB hard disk connected to the slug, taking as a parameter the device name for the specific partition to export. Along with providing the basic block interface, netblockd also implements the security functionality of the RRD.

We detect physical tokens and notify netblockd of their insertion and removal using the udev framework [29] When a USB thumb drive is inserted to the slug's open USB port, a udev script mounts it to /mnt/token and signals netblockd. netblockd will then use the label from that token when making access control decisions until it is removed, at which point the token is unmounted and its label cleared from the slug's memory.

The labels used to write protect disk blocks are stored in the BLOCK-LABELS data structure. This structure is kept in RAM while the slug is active, and saved to flash memory when powered off. When netblockd receives a write request, it obtains the labels corresponding to the requested blocks from BLOCK-LABELS, and compares them to those on the current physical token, if any. Because it is accessed on every write request, the search and insert operations on BLOCK-LABELS must contribute only negligible overhead to the total disk latency. It also must maintain metadata for potentially all blocks on the disk, within the space constraints of the disk's main memory, something that becomes more challenging as magnetic storage capacities increase.

File systems will attempt to store logically contiguous blocks, i.e. blocks in the same file, in a physically contiguous manner. We make use of this property by representing the disk as a set of contiguous ranges for which all blocks in a given range have the same label. If data is written to an unlabeled block, the write label from the current token, if there is one, must be added to BLOCK-LABELS. If this block is either adjacent to or between blocks of the same label, the ranges containing these blocks will be merged, reducing the size of the label structure. Searching BLOCK-LABELS requires logarithmic time in the number of ranges, and inserting a new range requires linear time. This is acceptable as the number of ranges is kept as small as possible.

In a typical RRD scenario, a standard SCSI or ATA driver would suffice for communication between the host and disk. Because our prototype exports a non-standard interface, we needed to implement an RRD device driver for the host machine. Note that while this driver is necessary to communicate with the RRD, neither it, nor the RRD to host protocol contain any security measures. The protocol contains only operations for reading, writing, obtaining the disk's geometry and reporting errors. For ease of implementation, we constructed the communication protocol in user space, leaving the block I/O interface in kernel space. The RRD driver consists of 1,314 lines of kernel code and 307 lines of user space code

In order to use our RRD as a root partition, we needed to mount it at boot time. This required the RRD driver to be run as part of the boot sequence. To achieve this, we created a Linux init ramdisk (initrd) image. This image contains a small ramdisk file system with utilities and drivers to be executed at boot time to prepare the device containing the root partition. Because the initrd is required to mount the RRD, it cannot be located on the RRD itself. Neither can the kernel or bootloader. We can, however, achieve the same security guarantees with our experimental setup by keeping the bootloader, kernel and initrd on a read-only media such as a CD-R. Note that in case of an IDE/ATA RRD, the BIOS can load these components from the disk at boot time, eliminating the need for the special RRD driver and initrd.

Performing an installation with an RRD requires knowing when the token should be present in the disk and when it should be removed. This could also require using multiple tokens at different stages of the install, e.g. binaries token and a configuration token. For this reason, it is desirable for the installer to cooperate with the administrator to simplify the installation process and make it less error-prone. To achieve this, the installer should require as little token changing as possible, while at the same time ensuring the mutual exclusivity of mutable and immutable data. We observe that the majority of data copied to the disk during installation is immutable. Most mutable data, that residing in logs and home directories, is created some time after the base installation.

We wrote a proof of concept installer script to install a base system onto an RRD. The installer's main function is to differentiate between data that should be mutable and immutable, as well as format portions of the filesystem as permanently mutable if necessary. It is focused on ensuring the mutually exclusive installation of mutable and immutable data. This is accomplished by installing mutable files and directories, asking the user for a token, and installing any immutable files and directories. We also modified mke2fs to label the appropriate data as permanently mutable. In this case, all structures except inodes are made permanently mutable. Inodes may need to become mutable to attacks in which inodes are pointed at trojan files and directories.

The key design decision in creating the installer is what data should be mutable or immutable. Making this decision is mainly a matter of identifying and write-protecting possible vectors for rootkit persistency. The MBR, boot loader, kernel and any kernel modules must be immutable to prevent overwriting by kernel level rootkits. Similarly, all libraries and binaries should be immutable to prevent user level rootkits from installing trojan versions. Protecting against overwriting is insufficient, as a rootkit may be stored in some free space on the disk, and loaded into memory at boot time. For this reason, any system configurations and startup scripts should be made immutable, along with scripts defining repeatedly executed tasks, e.g. cron. It may also be necessary to make root's home directory immutable to prevent a rootkit from being restarted due to some habitual action by the administrator, such as logging in. Header files such as those in/usr/include may be immutable to prevent the insertion of malicious code that could be compiled into applications built on the target system. Finer granularities of labeling may be achieved on a case to case basis, at the cost of administrative overhead.

The sequence of operations taken by our installer is as follows. The user is prompted to enter the permanently immutable token, at which point all file system metadata except inode tables are initialized. At this point the user removes the permanently immutable token, and the inode tables are created. Any mutable data including home directories is also written at this time. Finally, the user is prompted to enter the immutable token and the base system is copied to the disk.

TABLE I
Average completion time in seconds for Postmark

| Configuration | Completion (s) | % Overhead | 95% C.I. |
|---|---|---|---|
| nosec | 501.1 | — | [497.0, 505.5] |
| sec | 508.2 | 1.4% | [505.3, 511.2] |

TABLE II
Average Transactions Per Second for Postmark

| Configuration | TPS | % Decrease | 95% C.I. |
|---|---|---|---|
| nosec | 235.1 | — | [233.2, 236.7] |
| sec | 231.7 | 1.4% | [230.3, 232.7] |

TABLE III
Average microbenchmark results showing the amount
of time spent on disk and network I/O and security
operations in the RRD for Postmark.

| | | % Of | |
|---|---|---|---|
| Component | Total Time | Measured | 95% C.I. |
| disk | 132.9 | 59.0% | [130.6, 135.2] |
| Net | 78.4 | 34.8% | [77.0, 79.9] |
| security | 14.1 | 6.2% | [12.6, 15.5] |

Because storage is a significant bottleneck in most computer systems, we investigate the performance impact of the RRD's security measures. We accomplish this by running macro and micro benchmarks on our prototype RRD, and measuring the effects of block labeling on completion times and transactions per second. It is also possible for the layout of data on disk to have a dramatic effect on the size of BLOCK-LABELS, causing it to exceed the space constraints of the disk's NVRAM. Another concern regarding the labeling of data is the amount of disk space lost due to label creep. To better understand the effects of label creep, we measure the number of blocks in the disk that become unusable after relabeling. Finally, we investigate the ability of our prototype RRD to prevent rootkit persistence in a real system. In our evaluation of RRDs, we attempt to answer the following questions:
What are the performance overheads incurred by block labeling in the RRD?
How many disk blocks are lost due to label creep under a normal usage scenario?
How well do BLOCK-LABELS scale with the amount of labeled data written to disk?
Is the RRD effective in preventing rootkits from becoming persistent?

The answers to these questions will guide our analysis, and direct our future efforts at making RRDs more performance and resource efficient.

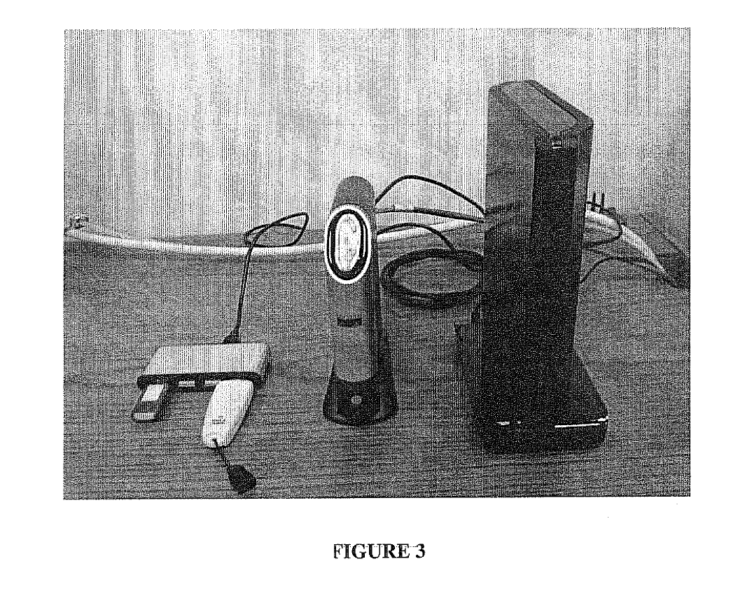

All experiments were performed using our prototype RRD comprising of a Linksys NSLU2 (slug) and a Seagate FreeAgent Pro external USB 2.0 hard drive, as shown in FIG. 3. The slug has a 266 MHz ARM IXP420 processor, and 32 MB of RAM. The slug ran the SlugOS 4.8 Linux distribution with a 2.6.21 kernel. The base system was stored on a partition on the external disk, and no swap space was used. The host system ran Ubuntu Linux with a 2.6.22 kernel on a 1.8 GHz Intel Core 2 Duo processor with 1 GB of RAM. In each experiment, the host was connected to the slug over a 100 MBps Ethernet link, or in the case of the scalability experiments, a switch to allow the host to download system upgrades.

In order to understand the performance implications of the RRD's policy, we evaluate our experimental prototype under two workloads. The Postmark benchmark is a standard file and storage system benchmark which performs transactions on a large group of many small files. Postmark is intended to simulate a typical load on a mail server, and is a good approximation of a random workload. In order to test the RRD under its expected operating conditions, i.e., administrative operations, we perform a system install to show the effects of block labeling for common administrative tasks.

We used Postmark version 1.51, configured to create 20,000 files of sizes ranging between 1 KB and 20 KB, and to perform 100,000 transactions. All other parameters were left to the default values. We ran the test 20 times, using a different random seed for each run and unmounting the RRD between runs to ensure a cold file system cache. The test was performed using two configurations: nosec in which the RRD was connected to the host via a direct Ethernet link and sec which was identical to nosec with the RRD's security measures enabled.

The completion times for each configuration as reported by Postmark are shown in Table I and the transactions per second in FIG. 2, along with the 95 percent confidence intervals as calculated using a T-distribution with 19 degrees of freedom. Being that Postmark is a random workload, the majority of the time used by security operations is spent searching and modifying the label data structure, BLOCK-LABELS. This task becomes more costly as many small, non-contiguous files are written to disk, increasing the size of the structure. As will be seen in the following experiment, more contiguous workloads can yield better performance.

To better understand the proportion of time spent on security as compared with the other components of I/O, we recorded microbenchmarks from within netblockd. These contain the time spent on disk access, network access and security. The disk access measurement is the total time spent by netblockd executing blocking read( ) and write( ) system calls to read and write blocks to the external hard drive. These do not include the overhead due to synchronization of the file system cache with the disk. The network measurement is the time spent by netblockd on blocking send( ) and recv( ) system calls to move data to and from the host. The security measurement is the time spent labeling blocks and performing access checks for write requests.

The results of the microbenchmarks are shown for the sec configuration in Table III. Note that these results do not account for the time writing back pages from the slug's page cache, and thus do not sum to the total execution time for the benchmark. They do, however, confirm that bus and disk access dominate security operations in the RRD. Furthermore, even in an implementation of the RRD within an enclosure that eliminated network overheads, the disk latency dominates the security overhead, such that policy lookups would not be a bottleneck.

TABLE IV
Average completion times in seconds for FS creation

| Configuration | Completion (s) | % Overhead | 95% C.I. |
|---|---|---|---|
| nosec | 289.3 | — | [288.3, 290.2] |
| sec | 291.8 | 0.8% | [291.1, 292.6] |

TABLE V
Average completion times in seconds for the base system copy

| Configuration | Completion (s) | % Overhead | 95% C.I. |
|---|---|---|---|
| nosec | 443.8 | — | [437.3, 450.3] |
| sec | 453.6 | 2.2% | [446.4, 461.0] |

TABLE VI
Microbenchmark results showing the amount of time
spent on disk and network I/O and security operations
in the RRD during the base system copy.

| | | % Of | |
|---|---|---|---|
| Component | Total Time (s) | Measured | 95% C.I. |
| disk | 340.5 | 53.8% | [340.1, 340.9] |
| net | 288.1 | 44.7% | [287.9, 288.5] |
| sec | 16.4 | 2.5% | [16.1, 16.7] |

Because the majority of labeling in an RRD occurs during administrative operations, we perform a simple system install. To achieve a worst-case scenario, we label all data in the system. For each run of the installation, we formatted the RRD with the ext2 file system and copied Ubuntu desktop Linux version 6.06 to the RRD from the host's hard disk. While this does not account for all activities of a typical system install, such as extracting archives and creating configurations, it does capture the I/O intensive operation of writing the system to the disk. The base system, which consisted of 949,657 files, was installed on a 100 GB partition on the RRD. We used the same two configurations as in the previous experiment.

The completion times for FS creation on each configuration as recorded by the time command are shown in Table IV, and base system copy time in Table V. In the case of contiguous raw I/O, as is seen in FS creation, block labeling and policy checking accounts for less than 1 percent of the completion time. This is due to the small size of BLOCK-LABELS, keeping search and insertion times short. The installation portion of the workload shows a larger overhead than FS creation due to the increasing size of BLOCK-LABELS as larger portions of the system are written to disk.

The results of the microbenchmarks for the System Install are shown in Table VI. Under the more contiguous workload of system installation, the percentage of overhead due to security operations is less than half that of the random workload. Note that in this case, disk I/O has also improved due to the large amount of contiguous writes.

As explained above, some blocks in an RRD may become unusable due to label creep. We will show that the number of blocks lost in this way represents only a small fraction of the disk in the worst-case scenario. We do this by measuring the difference between the number of disk blocks used by the file system and the number of labeled blocks during common administrative maintenance on the RRD's host system. Because the RRD maintains labels for potentially every block on the disk, we need to demonstrate that the amount of space overhead used for these labels does not become unreasonable. It is important that the space needed to store labels represent a small percentage of the total data on the disk so that RRDs may scale with the increasing capacities of magnetic storage mediums.

TABLE VII
The number of packages modified in each upgrade.

| | upgraded | new | removed | version |
|---|---|---|---|---|
| upgrade 1 | 820 | 170 | 85 | 6.10 |
| upgrade 2 | 907 | 185 | 33 | 7.04 |

In this test, we perform several common administrative tasks to simulate conditions under which labeling would occur on the RRD. We first install a file system and base OS as described in the previous experiment. We then reboot the host system, mounting the RRD as the root partition, and perform two full distribution upgrades: from 6.06 to 6.10 and from 6.10 to 7.04. The numbers of packages modified in each of these upgrades is shown in Table VII. At each of these four steps, we record the number of disk blocks used by the file system, and the number of blocks labeled by the RRD. We performed this test with two file systems, ext2 and ext3, which were chosen for their popularity as well as to determine the effects of journaling on label creep.

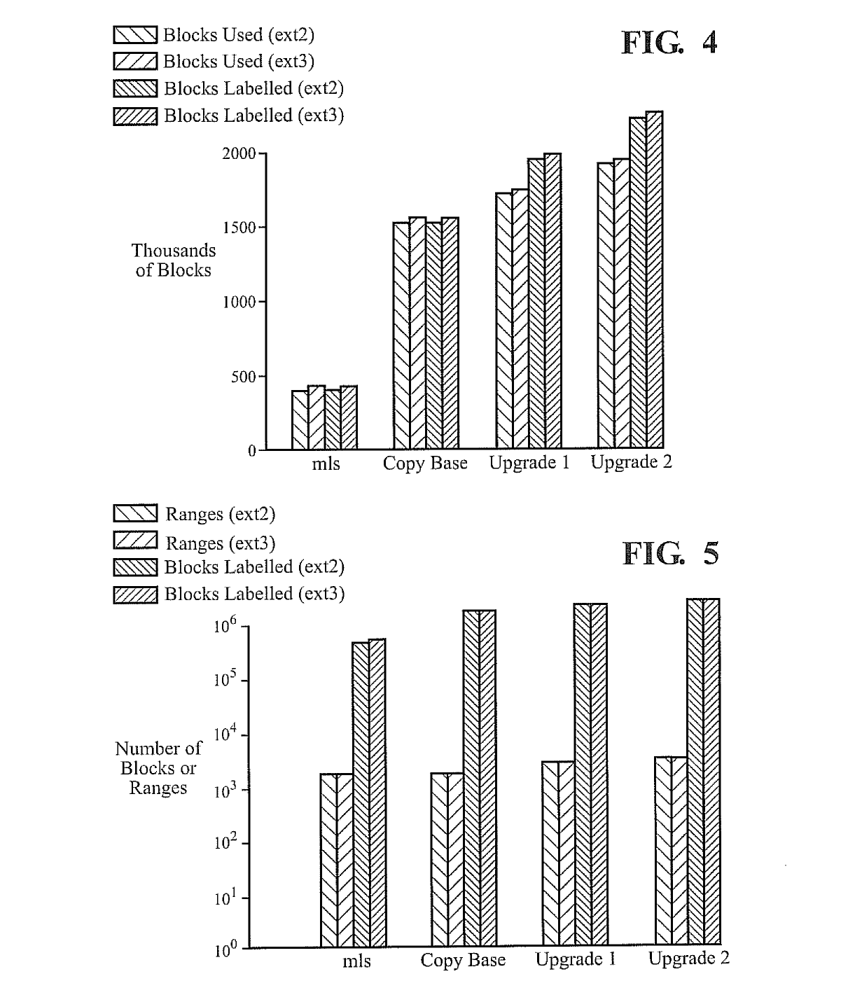

The results for both file systems are shown in FIG. 4. ext3 behaves the same as ext2 with the exception of a constant increase of 32,768 blocks to both the used and labeled blocks. This constant increase is due to the journal, which was labeled as permanently mutable at file system creation time. While the overhead due to label creep in both cases is roughly 10 percent of labeled data, it represents less than 1% of the total space on the partition. Because we tested the worst-case scenario by labeling all data in the base system, we have shown that in the worst case, label creep does not waste significant disk space.

We now evaluate the space efficiency of the RRD's label data structure as described earlier. We are mainly concerned with the size of the BLOCK-LABELS structure relative the number of labeled blocks. We perform the same tests as in the previous experiment, recording both the size of the labeled data and the size of BLOCK-LABELS at each step of FS creation, base copy, upgrade 1 and upgrade 2.

The results are shown in FIG. 5. From this figure, two things are evident. First, the label data structure is nearly three orders of magnitude smaller than the number of labels it represents. The label data structure also grows with a slower constant rate than the number of labeled blocks for the given workload. The second noteworthy characteristic of these results is that while the number of labeled blocks is larger in ext3 than ext2 by the constant size of the journal, BLOCK-LABELS remains completely unaffected. This is because the journal is represented by a single range, labeled as permanently immutable at FS creation time. In our implementation of BLOCK-LABELS, every range is 12 bytes in size, making its maximum size under 40 KB after the second upgrade, while the size of the system on disk was nearly 4 GB.

In order to test the ability of our prototype to correctly protect immutable data, we install a rootkit on a system booted from the prototype RRD, and verify that it fails to become persistent. We chose the Mood-NT rootkit [11], which is a persistent rootkit for Linux. Mood-NT works by trojaning the system call table. It can hide files, processes and network connections, as well as discover the location of the system call table for different kernel versions. Mood-NT gains persistence by replacing /sbin/init with its own initialization program. Upon reboot, this program installs the appropriate hooks in the system call table, and runs a backed up version of init to initialize the system as usual. This backup is hidden by trojan versions of the stat system call.

We created a base system using our installer script, which was configured to make all system binaries including init immutable, and rebooted the host machine from the RRD. Inspection of the system call table revealed that specific system calls had been replaced with malicious versions. It was apparent however, that the attempt to replace /sbin/init had failed due to a file system error. We rebooted the target machine and inspected the system call table for any signs that the rootkit had reinstalled itself. No system calls had been replaced, and there was no backed up version of init. We verified that the backup was not in its intended location by rebooting from the host machine's internal hard disk, and searching the suspect partition on the RRD. From these results we conclude that the prototype RRD successfully prevented the rootkit from becoming persistent

Given that the prototype RRD has been shown to successfully protect immutable data from writing in the absence of the appropriate token, we can safely generalize the set of persistent rootkits protected against by the prototype to all those that attempt to overwrite immutable data. This includes all data labeled immutable at installation time by the installer script as described above. Rootkits that normally overwrite files protected by our prototype system include t0rn, which overwrites common utilities such as netstat and ps [39], Suckit, which also overwrites /sbin/init, and Adore, which attempts to create files in /usr/lib and /usr/bin.

To better understand the scope of rootkits that write data to files normally labeled as immutable on an RRD, we examined a popular rootkit scanning program to see which files and directories it scans for evidence of rootkits. We chose chkrootkit [41], a collection of scripts that scan for rootkits on a variety of UNIX style systems include Linux, BSDs, Solaris and HP-UX. Our examination of chkrootkit version 0.47 revealed over 150 files and directories, labeled as immutable by the RRD, were scanned for modification by 44 known rootkits. chkrootkit performs two main types of checks. It inspects binary and configuration files for the presence of strings normally present in trojaned versions, and it checks for new files created by rootkits in system directories. The magnitude of files and directories examined by chkrootkit shows that RRDs can protect a large set of data normally tampered with by rootkits.

It is advantageous for the system partition of the filesystem to have its files protected through an administrative token. Without the token in place, these files may not be overwritten. A challenge comes with the use of the atime attribute for UNIX-based filesystems, however. Consider, for example, an extended Linux filesystem, e.g., ext2. When binaries are installed to the RRD with an installed token, both the file's blocks and its associated metadata blocks will be labeled with the token. In a Linux system, whenever a file is accessed, regardless of whether it is modified or otherwise changed, the time it was accessed, or atime, is affected. Because the administrative token is not meant to be used during regular system operation, metadata blocks associated with any programs written under the token will not be writable. For example, if Firefox is written under an administrative token and it is subsequently opened by a regular user, the inode's atime attribute will not be refreshed. Generally, atime is seen as a major detriment to performance [9] and in the Linux 2.6 kernel it is possible, and common, to disable atime altogether by mounting the filesystem with the noatime attribute.³ Disabling atime does break POSIX compliance but the number of programs affected by the lack of atime is small; system administrators should verify that their programs run properly in the absence of atime before committing to this change. 3 The NTFS filesystem has a similar access time check, which may be stopped by modifying the NtfsDisableLastAccessUpdate registry key.

While an RRD will function with a variety of current, unmodified filesystems, there are some small filesystem modifications that could help to improve the interaction between the file and storage layers. We consider the inode descriptor table in a UNIX-like filesystem. There are many tens of thousands of descriptor blocks when a filesystem such as ext2 is installed on a modern hard drive, and subsequently, millions of inodes are capable of being accessed. If a previously mutable inode descriptor block is written while a token is present, the block will become immutable under that token. Subsequently, if there is a write request and free inode descriptors are available in the block, the filesystem may attempt to write data to the block. This will fail if the token is not present, and the filesystem will have no knowledge that the write failed because of a lack of access privileges, but would rather be a message such as “BAD BLOCK”.

A small change to the filesystem could be made such that when the error message is received, the request is not retried but rather a different (potentially non-contiguous) block from the inode descriptor table is chosen. In addition, the filesystem often intersperses write requests across multiple inode descriptor blocks. A very small change that favors contiguous allocation of inodes will minimize the number of descriptor blocks that will be labeled in the event of a write request. A file system tool that instructs journaling file systems such as ext3 to write all changes in the journal to disk, would prevent write denied errors from the disk when attempting to sync journal blocks to labeled disk blocks after the token has been removed.

Performing administrative and maintenance tasks on RRDs is hampered by the necessity of not trusting the operating system. This is a model in stark contrast to what is currently accepted, where disk utilities that run through the operating system provide easy access to administrative functions. Consider, for example, the task of duplicating an RRD token for purposes of redundancy or backup. In a conventional system, this could occur through a program run by the user that presents a graphical user interface, guiding the user step by step through the required functionality. Unfortunately, any opportunity for the operating system to control functions on the disk is an opportunity to incorrectly label data and cause privilege escalation. As a result, maintenance operations must be performed in a manner that allows for direct interfacing with the RRD without the use of the OS as an intermediary. A non-exhaustive list of tasks that the RRD may be directly called upon to perform includes the following:
a Token cloning and disk backup;
Revocation of existing tokens and token escrow;
Large-scale token management and initial RRD configuration.

Below, we present some potential solutions to address or mitigate some of these issues. These investigations are preliminary and understanding them in greater detail is an ongoing research initiative. We assume that the RRD has at least two available slots for the insertion of USB tokens, and that it is shipped with two additional tokens: a “backup” token and an “unlabel” token.

To avoid reliance on the OS, one potential solution for token duplication is to ensure that the RRD has two available USB slots for tokens to be inserted. Then, the token to be duplicated is inserted in one slot, while a blank token is inserted in the other slot. Sensing the blank token, the RRD duplicates the contents of the first token onto the second.

With the availability of token duplication, backup without use of the OS is simplified. Backing up data on an RRD is now a matter of duplicating the backup token, retrieving another empty RRD of the same capacity, connecting the two devices together, and inserting a backup token in each drive. A block copy will then be performed along with a transfer of metadata between drives. Because this is a block copy, the geometry of the disks does not have to be identical. We are investigating the problem of backing up a source drive to a larger destination drive that may incorporate the backup data while simultaneously being able to store other information.

The unlabel token comes into use if a label is to be revoked from the disk, e.g., multiple users use the disk and label particular files as immutable with their own token, and a revocation occurs. By inserting the token of the revoked user⁴ along with the unlabel token, all block labels associated with the token will be erased from the RRD's metadata. As a result, these blocks will become mutable and all of the data may be reclaimed. 4 We assume that the system administrator has created a duplicate copy of this token.

In environments with many homogeneous machines, performing upgrades with a single hardware token is at best cumbersome and at worst infeasible, necessitating an alternative approach. A common method for rapidly deploying software to large numbers of machines is disk imaging or cloning. Our proposed solution calls for a single master machine to broadcast instructions to other RRDs through a channel that does not involve the OS. For example, software may be installed and configured on a single archetypal machine that is trusted. This machine's hard disk image is then simultaneously copied to many clone machines. Mutable data may be imaged to these clone machines, but when the token to allow modification of immutable data is inserted into the archetypal RRD, it broadcasts as message to the clone RRDs over a shared medium, such as wirelessly or over a USB bus, to allow writing of immutable blocks and labeling them appropriately. When the token is removed from the archetypal RRD, another message is broadcast that prevents further information from being labeled immutable. A similar process is followed when the archetypal system is to be upgraded.

RRDs can maintain their independence of operating systems by ensuring the correct partitioning of mutable versus immutable files during installation and upgrading of the operating system and its applications. While we have focussed on a Linux implementation, an. RRD solution would also be suitable for Windows installations. The layout of immutable files differs between Windows and UNIX-type OSes, with system-critical files often residing in the \Windows and \Windows\System32 directories, among others. While the installation process on a Windows system would require some small alterations such that immutable files were installed after the token was installed in the disk, the changes in this sense are similar to those required with a UNIX distribution and could be managed in much the same way. The same is true of using applications such as Windows Update to update the operating system; as many system-critical upgrades require a reboot already, the change from a user's standpoint would be fairly small.

Unlike in a UNIX-type system, configuration and other parameters are centralized in the Windows registry. The registry is not a single database, however; it is split into a number of sections, called hives, that localize functionality. For example, the HKEY_LOCAL_MACHINE hive stores global settings, while HKEY_CURRENT_USER stores settings specific to a particular user. These settings are stored in binary files in specific portions of the operating system. Notably, HKEY_LOCAL_MACHINE has its settings stored in a set of files in the \System32\Config directory that are associated with subkeys dealing with security and software settings among others. Because these files may be accessed separately from other registry entries, these files may be marked immutable, as they affect the entire system operation in much the same way as files within the /etc hierarchy, without requiring reboots for other less-critical registry operations.

Windows Vista supports registry virtualization [37], where applications that require access to read-only settings, such as system registry settings, can be remapped to locations that do not affect the entire system. In a similar manner, some applications made to interoperate with Windows Vista and older versions of Windows support application virtualization, where all of an application's registry operations are remapped to another location, such as a file in a user's space. Through these methods, applications may be accessed and upgraded without accessing system-critical portions of the registry and requiring changing of immutable files.

This application has detailed the design, operation and evaluation of rootkit resistance disks (RRD). RRDs label immutable system binaries and configuration during initial system installation and upgrades—an operation only available when a physical administrator token is plugged into the disk controller USB interface. Any attempt to modify these immutable blocks when the administrator token is not present, i.e., during normal operation of the operating system, is blocked by the disk controller. In enforcing immutability at the disk controller, we prevent a compromised operating system from infecting its on-disk image. Thus, while a rootkit can infect the system, the RRD will prevent it from becoming persistent. Our performance evaluation shows that the overheads associated with the RRDs are low—as little as 1.5% overhead was seen in the I/O intensive postmark benchmarks, and 1% or less during initial filesystem system creation. We further validated our approach by installing a real-world rootkit on an RRD-enabled system and were able to prevent the malware from infecting the on-disk system image and recover the OS into a safe state.

### REFERENCES

[1] M. K. Aguilera, M. Ji, M. Lillibridge, J. MacCormick, E. Oertli, D. Andersen, M. Burrows, T. Mann, and C. A. Thekkath. Block-Level Security for Network-Attached Disks. In Proceedings of the 2nd USENIX Conference on File and Storage Technologies (FAST'03), San Francisco, Calif., April 2003.
[2] S. Aubert. rkscan: Rootkit scanner for loadable kernel module rootkits. http://www.hsc.fr/ressources/outils/rkscan/index.html.en, October 2002.
[3] S. Baker and P. Green. Checking UNIX/LINUX Systems for Signs of Compromise, May 2005.
[4] A. Bellissimo, J. Burgess, and K. Fu. Secure software updates: disappointments and new challenges. In Proceedings of USENIX Hot Topics in Security (HotSec), July 2006.http://prisms.cs.umass.edu/˜kevinfu/papers/secureupdates-hotsec06.pdf.
[5] M. Blaze. A Cryptographic File System for UNIX. In Proceedings of the 1st ACM Conference on Computer and Communications Security (CCS'93), Fairfax, Va., USA, November 1993
[6] J. Butler and G. Hoglund. VICE-Catch the Hookers! In Black Hat 2004, Las Vegas, Nev., July 2004.
[7] G. Cattaneo, L. Cauogno, A. D. Sorbo, and P. Persiano. The design and implementation of a transparent cryptographic file system for UNIX. In Proceedings of the 2001 USENIX Annual Technical Conference, Boston, Mass., USA, June 2001.
[8] K. Chian and L. Lloyd. A Case Study of the RustockRootkit and Spam Bot. In Proceedings of the 1st USENIX Workshop on Hot Topics in Understanding Botuets (HotBots'07), Cambridge, Mass., USA, April 2007.
[9] J. Corbet. Once Upon atime.http://Iwn.net/Articles/244829/, August 2007.
[10] M. D. Corner and B. D. Noble. Zero-Interaction Authentication. In Proceedings of ACM MOBICOM, Atlanta, Ga., September 2002.
[11] DarkAngel. Mood-NT. http://darkangel.antifork.org/codes.htm.
[12] J. G. Dyer, M. Lindermann, R. Perez, R. Sailer, L. van Doom, S. W. Smith, and S. Weingart. Building the IBM 4758 Secure Coprocessor. IEEE Computer, 39(10):57-66, October 2001
[13] E. Filial. Concepts and future trends in computer virology, 2007.
[14] P. Fogla, M. Sharif, R. Perdisci, O. Kolesnikov, and W. Lee. Polymorphic Blending Attacks. In Proceedings of the USENIX Security Symposium, Vancouver, BC, Canada, August 2006.
[15] K. Fu, M. F. Kaashoek, and D. Mazieres. Fast and secure distributed read-only file system. ACM Trans. Comput. Syst., 20(1):1-24, February 2002.
[16] G. A. Gibson, D. F. Nagle, K. Amiri, J. Butler, F. W. Chang, H. Gobioff, C. Hardin, E. Riedel, D. Rothberg, and J. Zelenka. A Cost-Effective, High-Bandwidth Storage Architecture. In Proceedings of the 8th ACM Conference on Architectural Support for Programming Languages and Operating Systems (ASPLOS-VIII), San Jose, Calif., USA, October 1998.
[17] G. A. Gibson, D. F. Nagle, K. Amiri, F. W. Chang, E. Feinberg, H. Gobioff, C. Lee, B. Ozceri, E. Riedel, and D. Rochberg. A case for network-attached secure disks. Technical Report CMU-CS-96-142, Carnegie Mellon University, Pittsburgh, Pa., USA, September 1996.
[18] E.-J. Goh, H. Shacham, N. Modadugu, and D. Boneh. SiRiUS: Securing Remote Untrusted Storage. In Proceedings of the 10th ISOC Symposium on Network and Distributed Systems (NDSS'03), San Diego, Calif., USA, February 2003.
[19] J. B. Grizzard. Towards Self-Healing Systems: Re-establishing Trust in Compromised Systems. PhD thesis, Georgia Institute of Technology, 2006.
[20] Trusted Ccomputing Group. Stopping Rootkits at the Network Edge, January 2007.
[21.]Halflife.Abuse of the Linux Kernel for Fun and Profit. Phrack, 7(50), April 1997.
[22] D. Harley and A. Lee. The Root of All Evil?—Rootkits Revealed. http://www.eset.com/download/whitepapers/Whitepaper-Rootkit_Root_Of_All %_Evil.pdf, 2007.
[23] J. Heasman. Implementing and Detecting and ACPI BIOS Rootkit. In Black Hat Federal 2006, Washington, D.C., USA, January 2006.
[24] G. Hoglund and J. Butler. Rootkits: Subverting the Windows Kernel. Addison-Wesley, 2006.
[25] M. Kallahalla, E. Riedel, R. Swaminathan, Q. Wang, and K. Fu.Plutus: Scalable Secure File Sharing on Untrusted Storage. In Proceedings of the 2nd USENIX Conference on File and Storage Technologies (FAST'03), San Francisco, Calif., April 2003.
[26] B. Kauer. OSLO: Improving the security of Trusted Computing. In Proceedings of the 16th USENIX Security Symposium, Boston, Mass., USA, August 2007.
[27] G. H. Kim and E. H. Spafford. Experiences with Tripwire: Using Integrity Checkers for Intrusion Detection. Technical Report CSD-TR_{—}94-012, Department of Computer Sciences, Purdue University, West Lafayette, Ind., February 1994.
[28] S. T. King, P. M. Chen, Y.-M. Wan, C. Verbowski, H. J. Wang, and J. R. Lorch. SubVirt: Implementing malware with virtual machines. In Proceedings of the 2006 IEEE Symposium on Security and Privacy, Oakland, Calif., May 2006.
[29] G. Kroah-Hartman. udev—A Userspace Implementation of devfs. In Proceedings of the Ottawa Linux Symposium (OLS), Ottawa, ON, Canada, July 2002.
[30] C. Kruegel, W. Robertson, and G. Vigna. Detecting Kernel-Level Rootkits Through Binary Analysis. In Proceedings of the Annual Computer Security Applications Conference (ACSAC), Tuscan, Ariz., December 2004.
[31] M. Lauer. Building Embedded Linux Distributions with BitBake and OpenEmbedded. In Proceedings of the Free and Open Source Software Developers' European Meeting (FOSDEM), Brussels, Belgium, February 2005.
[32] J. Li, M. Krohn, D. Mazières, and D. Shasha. Secure Untrusted Data Repository (SUNDR). In Proceedings of the 6th USENIX Symposium on Operating Systems Design and Implementation (OSDI 2004), San Francisco, Calif., December 2004.
[33] Linksys.NSLU2 Product Information. http://www.linksys.com/servlet/Satellite?childpagename=US%2FLayout&pack%edargs=c%3DL_Product_C2%26cid%3D1118334819312&pagename=Linksys%2FCommon%2FVisi%torWrapper, April 2008.
[34] P. Loscocco and S. Smalley. Integrating Flexible Support for Security Policies into the Linux Operating System. In Proceedings of FREENIX '01, Boston, Mass., June 2001.
[35] D. Mazieres, M. Kaminsky, M. F. Kaashoek, and E. Witchel. Separating key management from file system security. In Proceedings of the 17th ACM Symposium on Operating Systems Principles (SOSP'99), pages 124-139, Kiawah Island, S.C., USA, December 1999.
[36]Metasploit Development Team.Metasploit Project. http://www.metasploit.com, 2008.
[37] Microsoft.Registry Virtualization (Windows).http://msdn.microsoft.com/en-us/library/aa965884.aspx, June 2008.
[38] E. L. Miller, W. E. Freeman, D. D. E. Long, and B. C. Reed. Strong Security for Network-Attached Storage. In Proceedings of the 1st USENIX Conference on File and Storage Technologies (FAST'02), Monterey, Calif., USA, January 2002.
[39] T. Miller. Analysis of the T0rn Rootkit.http://www.securityfocus.com/infocus/1230, November 2000.
[40] N. Murilo and K. Steding-Jessen.Métodos Para Detecçāo Local de Rootkits e Módulos de Kernel MaliciososemSistemasUnix. In Anais do III SimpósiosobreSegurançaemInformática (SSI'2001), Sāo José dos Campos, SP, Brazil, October 2001.
[41] N. Murilo and K. Steding-Jessen.Chkrootkit v. 0.47.http://www.chkrootkit.org/, December 2007.
[42] A. Oprea and M. K. Reiter. Integrity Checking in Cryptographic File Systems with Constant Trusted Storage. In Proceedings of the 16th USENIX Security Symposium, Boston, Mass., USA, August 2007.
[43] A. Oprea, M. K. Reiter, and K. Yang. Space-Efficient Block Storage Integrity. In Proceedings of the 12th ISOC Symposium on Network and Distributed Systems Security (NDSS'05), San Diego, Calif., USA, February 2005.
[44]PandaLabs.Quarterly Report (January-March 2008). http://pandalabs.pandasecurity.com/blogs/images/PandaLabs/2008/04/01/Quarterly_Report_PandaLabs_Q1_{—}2008.pdf?sitepanda=particulares, March 2008.
[45] A. G. Pennington, J. D. Strunk, J. L. Griffin, C. A. N. Soules, G. R. Goodson, and G. R. Ganger. Storage-based Intrusion Detection: Watching storage activity for suspicious behavior. In Proceedings of the 12th USENIX Security Symposium, Washington, D.C., USA, August 2003.
[46] B. C. Reed, M. A. Smith, and D. Diklic. Security Considerations When Designing a Distributed File System Using Object Storage Devices. In Proceedings of the 1st IEEE Security in Storage Workshop (SISW'02), Greenbelt, Md., USA, December 2002.
[47] J. Rutkowska. Detecting Windows Server Compromises. In Proceedings of the HiverCon Corporate Security Conference, Dublin, Ireland, November 2003.
[48] A. Sabelfeld and A. C. Myers. Language-based Information Flow Security. IEEE Journal on Selected Areas in Communication, 21(1):5-19, January 2003.
[49] M. Sivathanu, V. Prabhakarn, F. I. Popovici, T. E. Denehy, A. C. Arpaci-Dusseau, and R. H. Arpaci-Dusseau. Semantically-Smart Disk Systems. In Proceedings of the 2nd USENIX Conference on File and Storage Technologies (FAST'03), San Francisco, Calif., April 2003.
[50] NSLU2—Linux. http://www.nslu2-linux.org/wild/SlugOS/HomePage, 2008.
[51] D. Soeder and R. Permeh. eEyeBootRoot. In Black Hat 2005, Las Vegas, Nev., USA, July 2005.
[52] Y. Song, M. E. Locasto, A. Stavrou, A. D. Keromytis, and S. J. Stolfo. On the Infeasibility of Modeling Polymorphic Shellcode. In Proceedings of the 14th ACM Conference on Computer and Communications Security (CCS'07), Alexandria, Va., October 2007.
[53] E. H. Spafford. The Internet worm program: An analysis. ACM Computer Communication Review, 19(1):17-57, January 1989.
[54] S. Sparks and J. Butler. Shadow Walker: Raising the Bar for Windows Rootkit Detection. Phrack, 11(63), August 2005.
[55] D. Spinellis. Reliable Identification of Bounded-length Viruses is NP-Complete. IEEE Transactions on Information Theory, 49(1):280-284, January 2003.
[56] L. St. Clair, J. Schiffman, T. Jaeger, and P. McDaniel. Establishing and Sustaining System Integrity via Root of Trust Installation. In Proceedings of the 23rd Annual Computer Security Applicatons Conference (ACSAC 2007), Miami Beach, Fla., December 2007.
[57] S. Staniford, D. Moore, V. Paxon, and N. Weaver. The Top Speed of Flash Worms. In Proceedings of the ACM Workshop on Rapid Malcode (WORM), Washington, D.C., October 2004.
[58] J. D. Strunk, G. R. Goodson, M. L. Scheinholtz, C. A. N. Soules, and G. R. Ganger. Self-Securing Storage: Protecting Data in Compromised Systems. In Proceedings of the 4th Symposium on Operating Systems Design and Implementation (OSDI'00), San Diego, Calif., USA, October 2000.
[59] K. Thompson. Reflections on Trusting Trust. Communications of the ACM, 27(8):761-763, August 1984.
[60] P. Vixie. cron man page. http://www.hmug.org/man/5/crontab.php.
[61] H. Yin, D. Song, M. Egele, C. Kruegel, and E. Kirda. Panorama: Capturing System-wide Information Flow for Malware Detection and Analysis. In Proceedings of the 14th ACM Conference on Computer and Communications Security (CCS'07), Alexandria, Va., November 2007.
[62] E. Zadok, I. Badulescu, and A. Shender.Cryptfs: A Stackable Vnode Level Encryption File System. Technical Report CUCS-021-98, Columbia University, New York, N.Y., USA, 1988.
[63] Y. Zhu and Y. Hu. SNARE: A Strong Security System for Network-Attached Storage. In Proceedings of the 22nd International Symposium on Reliable Distributed Systems (SRDS'03), Florence, Italy, October 2003.

1. In a computer system wherein a host processor communicates with a storage device operated by a storage-device controller, a method of protecting the storage device against rootkit exploitation, comprising the steps of:
physically installing a token in the storage device during the installation of an operating system on the host processor or during a system upgrade, such that regions of the storage device are labeled as immutable by the token; and
removing the token following the installation or upgrade, such that any attempted modification of an immutable region during normal operation of the host processor is blocked by the storage device controller.

2. The method of claim 1, wherein the storage device is a disk drive possessing a token interface.

3. The method of claim 1, wherein the token can only be installed by a system administrator.

4. The method of claim 1, wherein the token is installed during file system creation, system installation or package installation.

5. The method of claim 1, wherein the regions of the storage device are blocks of data.

6. The method of claim 1, wherein the token is physically plugged into the storage device using a smart card, USB token, flash drive or other device.

7. The method of claim 1, wherein the regions of the storage device include binary data, a master boot record (MBR), or storage regions susceptible to being overwritten by a rootkit.

8. A system for protecting a storage device operated by a controller in communication with a host processor against rootkit exploitation, the system comprising:
an input on the storage device for receiving a token used to label particular data stored on the storage device as write-protected; and
whereby the controller is operative to monitor write operations within the storage device received from the host processor and deny write operations targeting the data identified as write-protected.

9. The system of claim 8, wherein the storage device is a disk drive possessing a token interface.

10. The system of claim 8, wherein the token is physically plugged into the storage device.

11. The system of claim 8, wherein the token is physically plugged into the storage device using a smart card, USB token, flash drive or other device.

12. The system of claim 8, wherein the data to be write-protected includes binary data, a master boot record (MBR), or storage regions susceptible to being overwritten by a rootkit.
